(19) United States
(12) Patent Application Publication
(10) Pub. No.: US 2003/0148664 A1
(43) Pub. Date: Aug. 7, 2003

(54) Connection port structure of CF card

(76) Inventor: Chih-Jen Cheng, Zao Qvio Town (TW)

Correspondence Address: BACON & THOMAS, PLLC, 625 SLATERS LANE, FOURTH FLOOR, ALEXANDRIA, VA, 22314

(21) Appl. No.: 10/066,652

(22) Filed: Feb. 6, 2002

(51) Int. Cl. H01R 25/00

(52) U.S. Cl. 439/638

(57) ABSTRACT

A connection port structure of CF card provides a primary port for CF socket capable of connecting with the application devices such as PDA or digital camera and so on, in which it is characterized by extending from the primary port to form a secondary port locating at the opposite end of the primary port or at one side of the CF card. The secondary port can be a type of socket or a type of pin.

### BACKGROUND OF THE INVENTION

1. Field of the Invention

The invention relates to a connection port structure of CF card, particularly a device capable of connecting with the primary port for CF socket of application devices such as PDA or digital camera and so on, as well as the secondary port formed by extending from the primary port.

2. Description of the Background Art

As Personal Digital Assistant (PDA) is good at recording information and compact size ease of portability, providing the all-time information demands of user, as a result recently it already gradually replaces Personal Computer (PC) and Notebook (NB), becoming the most frequently used carry information processor of human being. Despite the said advantages, PDA is weak at data transmission speed in comparison with PC and NB. Under the current PDA structure, IR port and serial port are used for data transmission in which serial port is the most basic part used to provide as the interface for data exchange. The data transmission of serial port is conducted in serial way and the maximum transmission speed can only achieve 115 kbps. Due to smaller bandwidth, it is competent for general single frequency data transmission but is overwhelmed regarding the acquisition and storage of physiological signal in medical application. Consequently, the PDA applied in medical field by and large is in existence in form of database, such as medical inquiry system, mobile patient data building system or medical calculation software.

In contrast with the features of serial port, parallel port has relatively high bandwidth in terms of specifications and definition capable of being used for high speed data transmission and other signal acquisition and direct transmission of acquired data to PDA for synchronous data processing without requiring additional processor for data exchange. The parallel port are superior to serial port in terms of speed and cost. Take the physiological signal sample of Electrocardiogram (ECG) as example, under the no display mode, the acquired signal transmitting in parallel port can reach sampling rate at 30 KHz˜35 KHz and the data transmission rate can reach 60 Kbytes˜70 Kbytes, while the transmission with serial can only be 11 Kbytes, showing the transmission performance in parallel port much better than that of serial port.

The interface of PDA communicating with external equipment has serial port and IR port only, meanwhile, part of the new models already have design of parallel port and are applied with the specifications such as CompactFlash (CF) or Memory Stick (MS) and so forth. Most of the parallel port interface are used for memory expansion, for example CF Card, and it is specified and defined with very high bandwidth, which is very suitable for high speed data transmission and can synchronously transmit acquired data to PDA for processing without having to go through additional data exchange processor. Despite the advantage mentioned in the parallel port of PDA, the CF Card in use currently is the upgrade version of PDA system or the expansion card of other Operating System (OS), or can only access the inputted data from the serial port of PDA, hence it still can not directly input external data to PDA in spite of the advantage of parallel port.

### SUMMARY OF THE INVENTION

As CF Card is used in parallel port and perform fast data transmission acquisition, adding that it itself provides memory capacity from several MB up to several hundred MB, making it ideal for fast and multi-channel data access. However, the CF Card 1 of small flash memory card nowadays (as shown in FIG. 1) has only one external interface port 12 and the port is direction in connection with the parallel port of PDA. As such, it is practically feasible to provide interface for direct external connection. In view of this, the invention is to provide a new CF card, which also provides a primary port of parallel part for application devices like PDA, digital camera and so on and is characterized by forming a secondary port extending form the primary port and located on the opposite side of the primary port installed on CF Card or certainly capable of being located on any side adequately installing the secondary port on the CF Card. The secondary port can perform signal transmission along with the primary port, allowing external data can be inputted from the secondary port to the application device such as PDA and so on via the primary port. Moreover, the secondary port can also directly input external data to CF Card to construct another database. Such application method can be promoted to the medicine field for acquisition of physiological signal, i.e. various physiological signals such as ECG activities, blood pressure, heart output amount and so forth of human body are synchronously acquired and stored to the CF Card. The stored data can be further selected to store in PDA and then is stored back to PC plus application analysis; or can be directly displayed on PDA for the acquired signals. Hence, PDA won't be limited to the application model of pure database and can establish instant monitoring mobile medical system accordingly.

### BRIEF DESCRIPTION OF THE DRAWINGS

FIG. 1 is the conventional 3-D diagram for external look and structure of CF Card;

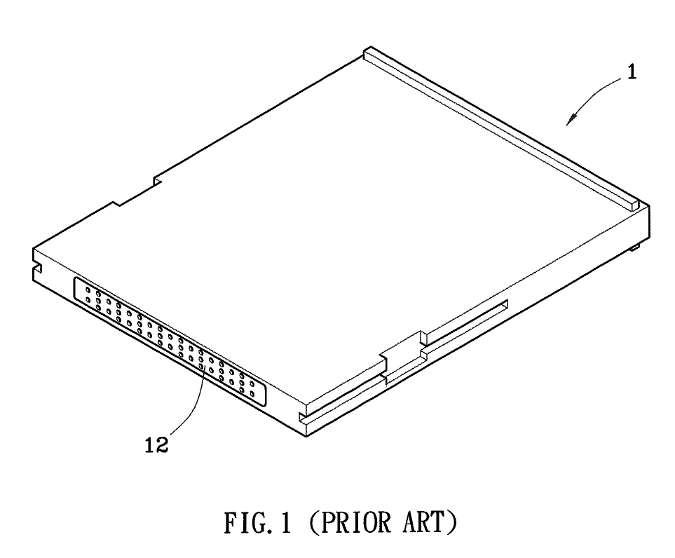

FIG. 2 is the 3-D diagram for external look and structure of CF Card of the invention;

FIG. 3 is the practical model diagram of the invention

### DESCRIPTION OF THE PREFERRED EMBODIMENTS

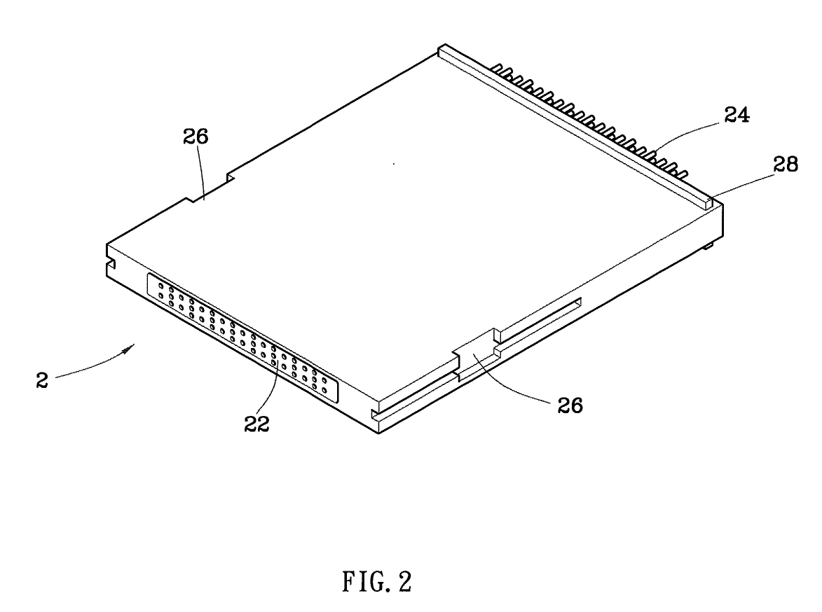

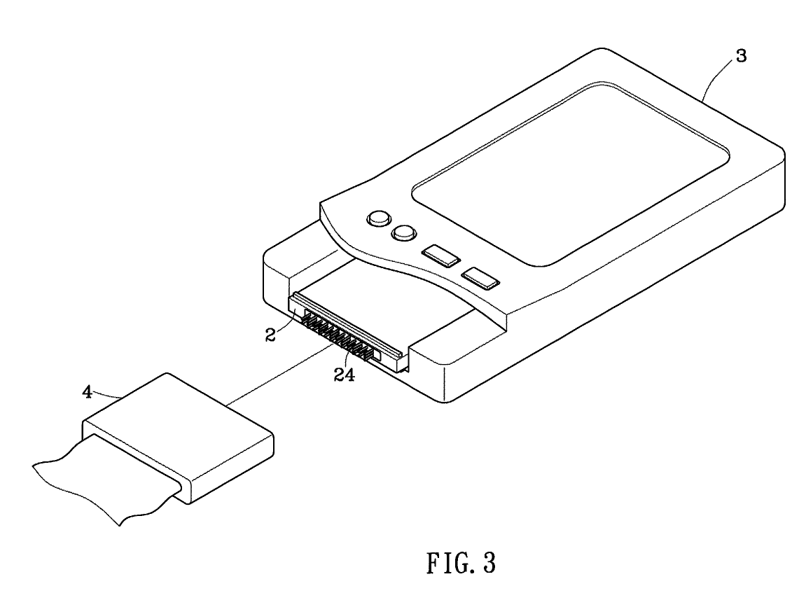

The invention provides a new type CF Card 2, in which the structure is shown as in FIG. 2, one side of which still provides the port 22 in connection with the parallel port of application devices of PDA, digital camera or game machine and so on. The port 22 is a type of socket for normal design. A port 24 on the opposite side of the port 22 is formed and the port 24 can be designed in form of pin as shown in Figure or possibly a type of socket. The CF Card 2 is formed with the guiding slot 26 of parallel port (not shown in Figure) over two sides without installation of ports 22 and 24 capable of integrating with application devices for PDA and so on, and the convex band 28 on side edge of port 24 for pulling off the CF Card 2. The above port 24 can be designed by forming circuit layout by extending from port 22 or by forming another port on the PCB at which port 22 is located, making the signal transmission capable of being conducted for the two ports. The implementation method of the invention is to plug the port 22 directly in the CF socket of PDA3 (not shown in Figure) as shown in FIG. 3. The port 24 of another end is protruded on the tail side of PDA3, in which the protruded port 24 can be provided to connect with external interface 4 to directly store data through the connection port 24 in fast and multi-channel way to the CF Card 2 of the invention without loaning other data conversion processor.

By means of the dual port design (22 & 24), the invention can acquire large amount of data and store them in itself, apparently becoming a memory device. Meanwhile, the invention can utilize the dual port 22 & 24 as interfaces to swiftly store large amount of data in PDA for direct display or further store in PC or NB for computation analysis. Likewise, with the model the invention still can be applied in the application devices other than PDA such as digital camera, digital voice recorder, game machine or mobile phone and so on.

What is claimed is:

1. A CompactFlash(CF) port structure, providing a primary port capable of being inserted in the CF socket of the application devices such as Personal Digital Assistant (PDA), digital camera and so on, is characterized by forming a secondary port extending from the said primary port and being located at one side of the CF device.

2. A CompactFlash port structure according to claim 1, wherein the secondary port is a socket.

3. A CompactFlash port structure according to claim 1, wherein the secondary is a pin.
